(19) United States
(12) Patent Application Publication
(10) Pub. No.: US 2019/0312371 A1
(43) Pub. Date: Oct. 10, 2019

(54) FEMALE TERMINAL AND CONNECTOR

(71) Applicant: SHARP KABUSHIKI KAISHA, Sakai City (JP)

(72) Inventors: YAN QIAN, Sakai City (JP); KEI URAKAWA, Sakai City (JP); NARAKAZU SHIMOMURA, Sakai City (JP)

(21) Appl. No.: 16/370,607

(22) Filed: Mar. 29, 2019

(30) Foreign Application Priority Data
Apr. 4, 2018 (JP) 2018-072610

(51) Int. Cl. H01R 13/11; H01R 4/48; H01R 13/15

(52) U.S. Cl. CPC H01R 13/111; H01R 13/15; H01R 4/48

(57) ABSTRACT

A socket electrically connectable with a pin inserted thereinto includes a pressed portion, which is pressed by the pin, and clamp pieces, which are deformed, in response to the pressed portion being pressed, into a clamp position, in which the clamp pieces clamp the pin therebetween, from an insertion position, in which the clamp pieces allow the pin to be inserted thereinto.

### BACKGROUND

### 1. Field

The present disclosure relates to a female terminal electrically connectable to a male terminal and a connector including the female terminal.

### 2. Description of the Related Art

An existing connector that electrically connects a male terminal and a female terminal with each other has a mechanism for reducing dirt such as plating residues produced after sliding the male terminal over the female terminal to fit the male terminal to the female terminal or a mechanism for hindering dirt from intruding into a contact portion between the male terminal and the female terminal. For example, Japanese Unexamined Patent Application Publication No. 2013-089309 (disclosed on May 13, 2013) discloses a technology for hindering dirt, such as plating residues produced after sliding a male terminal of a connector over a female terminal of the connector, from intruding into a contact portion between the male terminal and the female terminal by accumulating such dirt in a groove formed in the male terminal.

### SUMMARY

In the connector terminal disclosed in Japanese Unexamined Patent Application Publication No. 2013-089309 (disclosed on May 13, 2013), for example, in the circumstances where the male terminal is frequently pulled into and out of the female terminal, dirt accumulated in the groove may scatter from the groove. Under such circumstances, dirt intrudes into the contact portion between the male terminal and the female terminal to impair the reliability of electrical connection. Moreover, repeated sliding of the male terminal over the female terminal wears both the male terminal and the female terminal and reduces their lives.

The present disclosure, made in view of the above problems, provides a female terminal and a connector that prevent separation of plating on terminals, that improve the reliability of electrical connection, and that have long lives.

To address the above, a female terminal according to an aspect of the present disclosure is a female terminal electrically connectable to a male terminal inserted therein. The female terminal includes a pressed portion that is pressed by the male terminal, and a clamp portion that is deformed, in response to the pressed portion being pressed, into a clamp position, in which the female terminal clamps the male terminal, from an insertion position, in which the female terminal allows the male terminal to be inserted thereinto.

### BRIEF DESCRIPTION OF THE DRAWINGS

FIGS. 1A to 1F are cross-sectional views and perspective views of a socket and a pin according to an embodiment of the present disclosure;

FIGS. 2A to 2G are cross-sectional views of a socket according to an embodiment of the present disclosure including multiple clamp pieces;

FIGS. 3A to 3H are cross-sectional views of a socket and a pin according to another embodiment of the present disclosure;

FIGS. 4A to 4F are cross-sectional views of a socket and a pin according to another embodiment of the present disclosure;

FIGS. 5A to 5H are cross-sectional views of a socket and a pin according to another embodiment of the present disclosure;

FIGS. 6A to 6D are cross-sectional views of a socket and a pin according to another embodiment of the present disclosure;

FIGS. 7A to 7E are cross-sectional views of a connector according to an embodiment of the present disclosure in a fixed position; and

FIGS. 8A and 8B are cross-sectional views of a connector according to another embodiment of the present disclosure in a fixed position.

### DESCRIPTION OF THE EMBODIMENTS

### First Embodiment

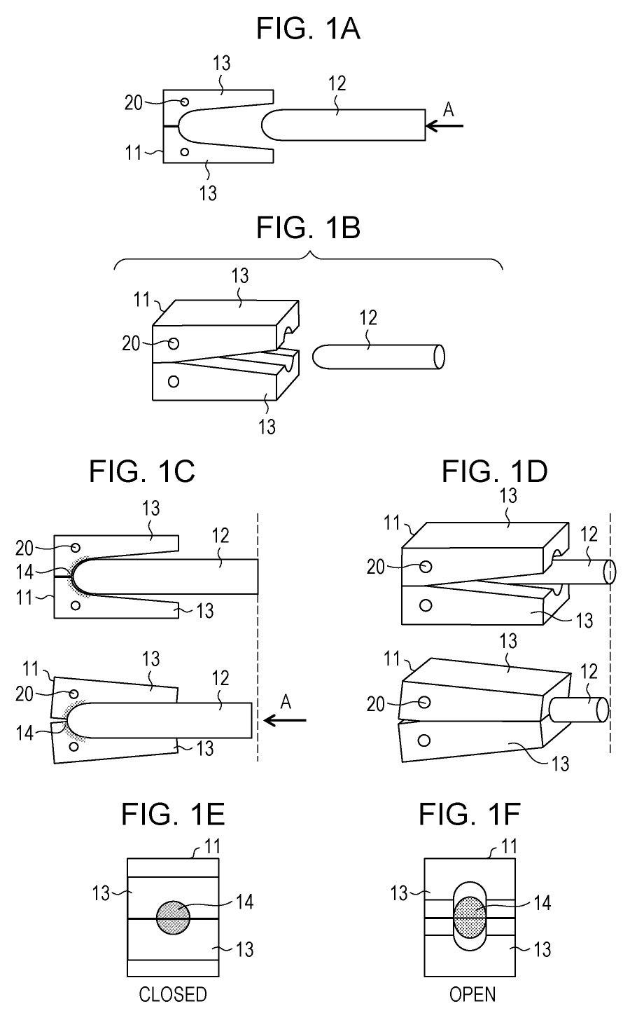

A female terminal and a connector 40 according to an embodiment of the present disclosure are described below. FIGS. 1A to 1F illustrate a socket 11 (female terminal) and pin 12 (male terminal) according to an embodiment of the present disclosure, where FIG. 1A is a cross-sectional view of the socket 11 in an insertion position to allow the pin 12 to be inserted thereinto, and FIG. 1B is a perspective view of the socket 11 in the insertion position in FIG. 1A. The upper half of FIG. 1C is a cross-sectional view of the state where the socket 11 starts being pressed into the pin 12, and the lower half of FIG. 1C is a cross-sectional view of the socket 11 in the clamp position to clamp the pin 12. The upper halt of FIG. 1D is a perspective view of the socket 11 in the insertion Position, and the lower half of FIG. 1D is a perspective view of the socket 11 in the clamp position.

As illustrated in FIGS. 1A and 1B, the socket 11 includes two clamp pieces 13 as clamp portions, and these two clamp pieces 13 form an alligator clip. An area where the two clamp pieces 13 face each other has a gap having a shape corresponding to the shape of the pin 12. The pin 12 has a shape of a stick with a rounded tip.

As the pin 12 is inserted further from the states illustrated in FIGS. 1A and 1B, as illustrated in the upper halves of FIGS. 1C and 1D, the tip of the pin 12 starts pressing the socket 11. The portion of the socket 11 thus pressed by the pin 12 is hereinafter referred to as “a pressed portion 14 (the shaded portion in FIGS. 1C, 1E, and 1F)”. As the pin 12 is pressed into the socket 11 further from the state where the pressed portion 14 starts being pressed by the pin 12, as illustrated in the lower halves in FIGS. 1C and 1D, the clamp pieces 13 rotate about their respective rotation shafts 20, and the pin 12 is clamped by the socket 11 (in the clamp position) since the pressed portion 14 has the shape corresponding to the tip of the pin 12.

FIG. 1E illustrates the socket 11, viewed in the direction of arrow A in FIG. 1C. FIG. 1F illustrates the socket 11, viewed in the direction of arrow A in FIG. 1A. FIGS. 1E and 1F do not illustrate the pin 12 for easy understanding.

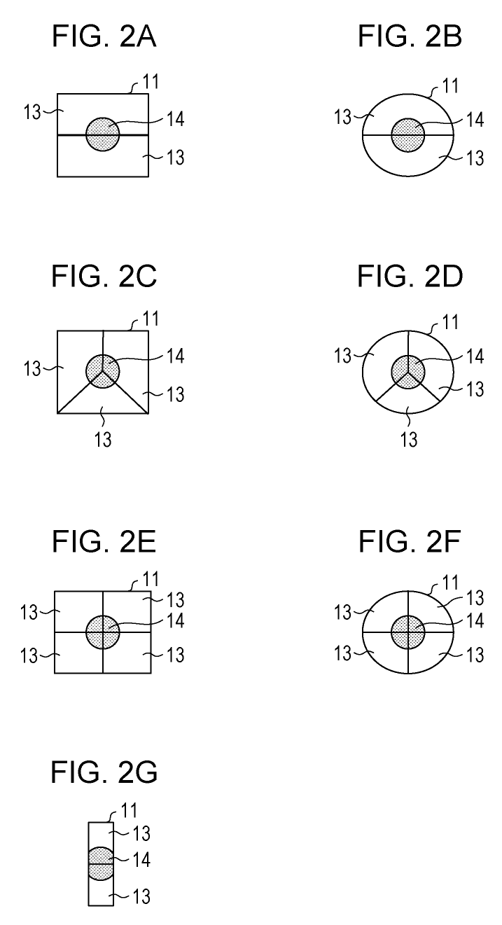

The shape of the socket 11 is not limited to the one illustrated in FIGS. 1A to 1F, and may be another one. This shape is described further with reference to FIGS. 2A to 2G. Firstly, as illustrated in FIGS. 2A, 2C and 2E, the socket 11 has a basically square cross section when taken along the plane perpendicular to the direction in which the pin 12 is inserted. However, the cross section is not limited to a square, and may be a rectangle, as illustrated in FIG. 2G, or a polygon other than a quadrilateral. Alternatively, as illustrated in FIGS. 2B, 2D and 2F, the socket 11 may have a circular or elliptic cross section when taken along the plane perpendicular to the direction in which the pin 12 is inserted.

Moreover, the socket. 11 may have any number of clamp pieces 13. Firstly, the socket 11 may be vertically separated into two sections with the two clamp pieces 13, as illustrated in FIGS. 2A and 2B, may be separated into three sections with three clamp pieces 13, as illustrated in FIGS. 2C and 2D, or may be separated into four sections with four clamp pieces 13 as illustrated in FIGS. 2E and 2F.

### Second Embodiment

The socket. 11 and the pin 12 according to embodiments of the present disclosure basically have the structure as described in the first embodiment. To reduce wear of the pin 12 or the socket 11 caused when the pin 12 is inserted into the socket 11, the socket 11 and the pin 12 may have any of various structures, which are described below.

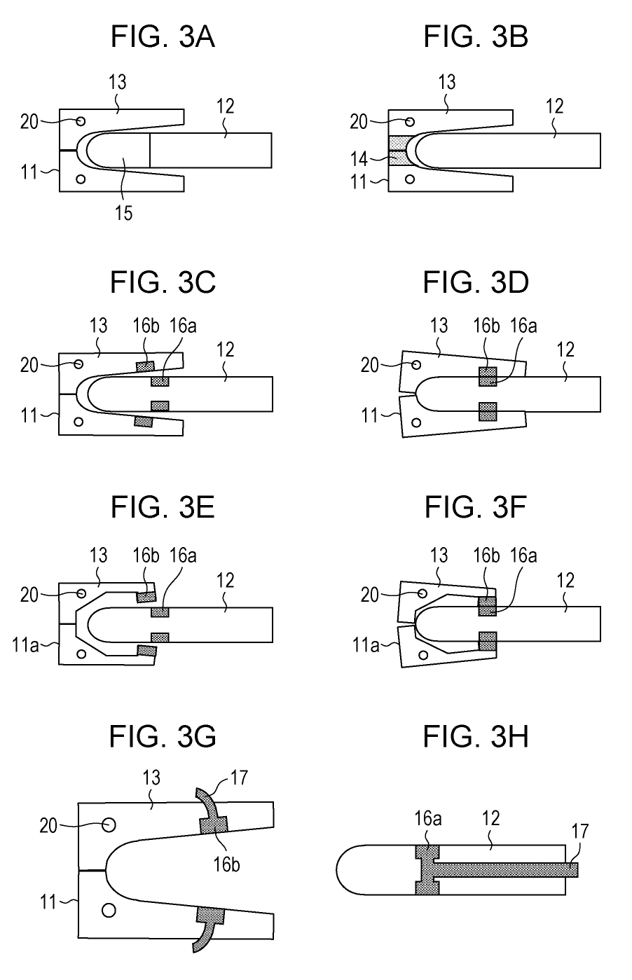

Firstly, as illustrated in FIG. 3A, a tip portion 15 of the pin 12 may be formed from a high wear-resistant material (such as resin or rubber), or, as illustrated in FIG. 3B, the pressed portion 14 of the socket 11 (shaded portion in FIG. 3B) may be formed from a high wear-resistance material. Thus, wear caused when the pin 12 is inserted into the socket 11 can be reduced.

As illustrated in FIG. 3C, contact points 16a of the pin 12 and contact points 16b of the socket 11 may be located at specific positions of the pin 12 and the socket 11 (for example, shaded positions in FIG. 3C), and portions other than the contact points may be formed from a non-conductive material. In this structure, as long as the pin 12 is inserted to such an extent as to allow the contact points 16b of the socket 11 and the contact points 16a of the pin 12 to come into contact with each other, as illustrated in FIG. 3D, the pin 12 does not have to be inserted into the socket 11 further. This structure can thus reduce wear caused when the pin 12 is inserted into the socket 11.

As illustrated in FIG. 3E or 3F, in the state where the pin 12 is clamped by a socket 11a, a gap may be formed between the socket 11a and the pin 12 in the area in which the pin 12 is enclosed by the socket 11a except the contact points of the pin 12 and the socket 11a and the pressed portion 14. To form such a gap, the inner sides (the sides for holding the pin 12) of the clamp pieces 13 of the socket 11a may have a cross-sectional shape that is bent to form a gap larger than the shape of the tip portion of the pin 12, instead of the shape substantially corresponding to the shape of the tip portion of the pin 12. The socket 11a and the pin 12 illustrated in FIGS. 3E and 3F can limit the portions at which the socket 11a and the pin 12 come into contact with each other in the clamp position, to the contact points and the pressed portion 14. Thus, wear caused when the pin 12 is inserted into the socket 11a can be reduced.

As illustrated in FIG. 3C or 3D, when the socket 11 has the contact points 16b located at specific positions, as illustrated in FIG. 3G, the socket 11 may include wires 17, which connect the contact points 16b to the outside of the socket 11, to guide electric signals obtained at the contact points 16b to the outside of the socket 11. Similarly, as illustrated in FIG. 3C or 3D, when the pin 12 has the contact points 16a located at specific positions, as illustrated in FIG. 3H, the pin 12 may include a wire 17, which connects the contact points 16a to the outside of the pin 12, to guide electric signals obtained at the contact points 16a to the outside of the pin 12.

### Third Embodiment

The socket 11 and the pin 12 according to the embodiment of the present disclosure may have various other structures for achieving preferable conductivity with improved contact between the pin 12 and the socket 11, which are described below.

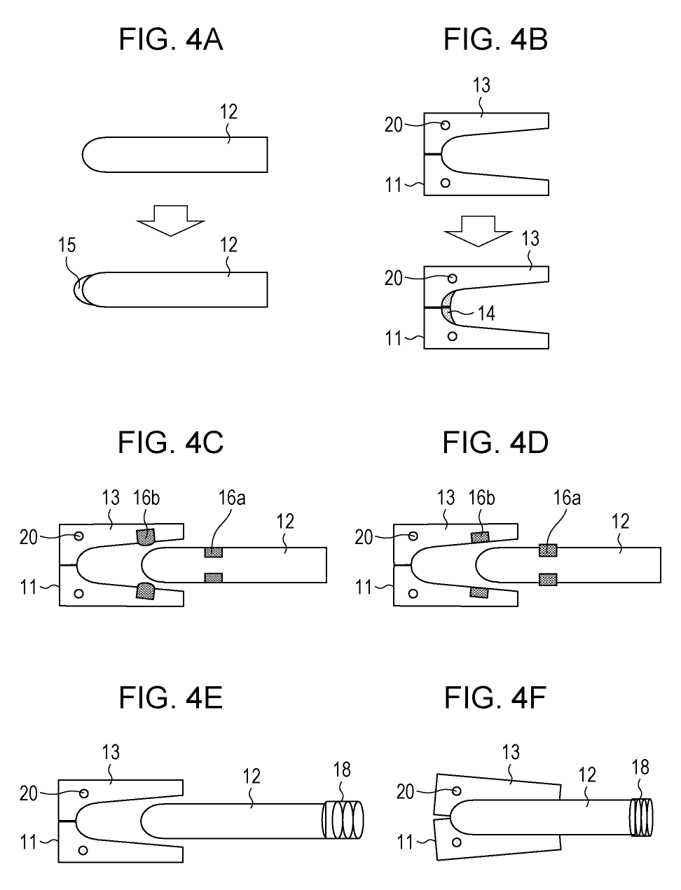

Firstly, the structure of the pin 12 is changed from the one illustrated on the upper side of FIG. 4A to the one illustrated on the lower side of FIG. 4A to have a larger tip portion 15 and extend the contact area between the pin 12 and the socket 11 in the clamp position. Thus, the electrical connection between the pin 12 and the socket 11 is improved. The structure of the socket 11 is also changed from the one illustrated on the upper side of FIG. 4B to the one illustrated on the lower side of FIG. 4B to have a larger pressed portion 14. This change also has the same effect as the change of the structure of the pin 12 illustrated in FIG. 4A.

Alternatively, as illustrated in FIG. 4C, the contact points 16b disposed on the socket 11 may be enlarged from the ones illustrated in FIG. 3C. Similarly, as illustrated in FIG. 4D, the contact points 16a disposed on the pin 12 may be enlarged from the ones illustrated in FIG. 3D. Also as illustrated in FIG. 4E, an urging portion (such as a spring 18) that urges the pin 12 to press the pin 12 against the socket 11 may be disposed at the rear of the pin 12 (on the end of the pin 12 opposite to the end from which the pin 12 is inserted into the socket 11). In any of the structures illustrated in. FIGS. 4C to 4F, the electrical connection between the pin 12 and the socket 11 can be improved.

### Fourth Embodiment

The socket 11 according to an embodiment of the present disclosure includes an urging portion that urges the multiple clamp pieces 13 away from each other in the insertion position, to reduce the possibility of contact between the pin 12 and the socket 11 during insertion of the pin 12 and removal of the pin 12. This point is described below.

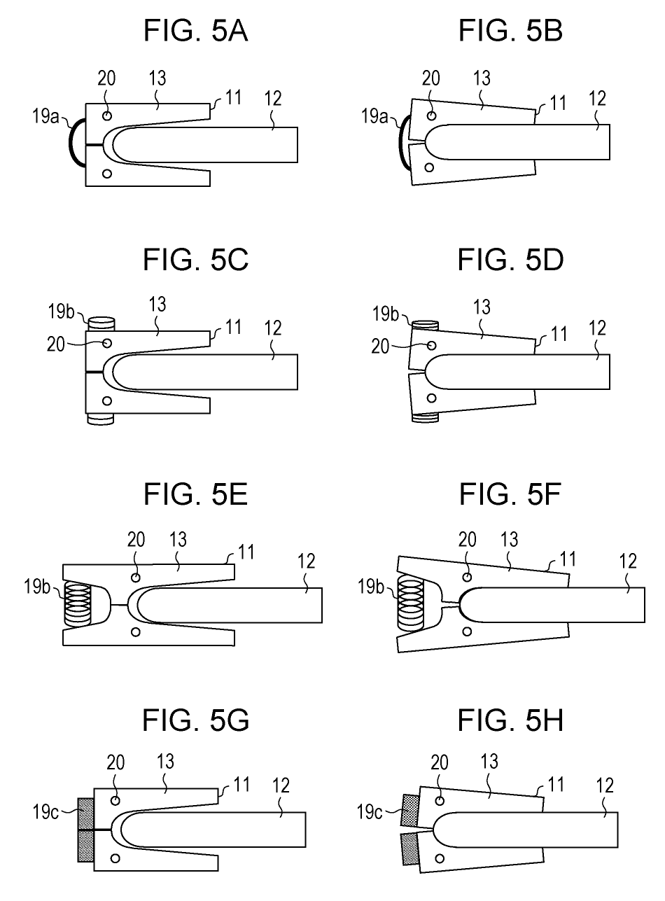

Firstly, as illustrated in FIG. 5A, a flat spring 19a may be disposed as an urging portion between the clamp pieces 13. The flat spring 19a has a force urging the clamp pieces 13 in the direction away from each other. Specifically, as illustrated in FIG. 5B, in the state where the pin 12 is clamped between the clamp pieces 13, the flat spring 19a applies, to the clamp pieces 13, a force of restoring to the state in FIG. 5A. In the insertion position illustrated in FIG. 5A, the flat spring 19a keeps the two clamp pieces 13 apart from each other. Thus, the possibility of contact between the pin 12 and the socket 11 can be reduced during insertion of the pin 12.

From the clamp position illustrated in FIG. 5B, when the pin 12 is retracted to separate the tip of the pin 12 away from the pressed portion, the flat spring 19a moves the two clamp pieces 13 away from each other. Thus, the possibility of contact between the pin 12 and the socket 11 can be reduced also during removal of the pin 12.

As illustrated in FIG. 5C, a spring 19b may be disposed as an urging portion on each of the clamp pieces 13. The spring 19b thus disposed applies, to each of the clamp pieces 13, a force of restoring to the state illustrated in FIG. 5C from the state illustrated in FIG. 5D, and also keeps, in the state illustrated in FIG. 5D, the two clamp pieces 13 apart from each other.

As illustrated in FIG. 5E, the clamp pieces 13 may be elongated further beyond the rotation shaft 20 in the direction in which the pin 12 is inserted, and a spring 19b may be disposed in a gap formed in the elongated portion. Alternatively, as illustrated in FIG. 5G, a magnet 19c may be disposed at a position further beyond each rotation shaft 20 in the direction in which the pin 12 is inserted.

The magnet 19c (urging portion) thus disposed applies, to each of the clamp pieces 13, a force of restoring to the state illustrated in FIG. 5G from the state illustrated in FIG. 5H, and also keeps the two clamp pieces 13 apart from each other, in the state illustrated in FIG. 5H. Thus, the spring 19b or the magnet 19c can also have the same effect as the structure illustrated in FIG. 5A or 5C.

### Fifth Embodiment

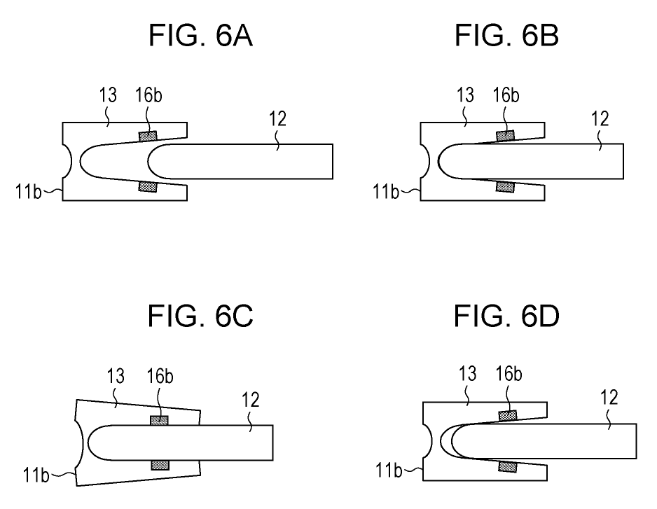

A socket 11b illustrated in FIGS. 6A to 6D is formed from an elastically deformable material (resin or rubber). The socket 11b is elastically deformed with the force of the pin 12 pressing the socket 11b into such a shape as to cover the pin 12 to enable electrical connection between the socket 11b and the pin 12.

FIG. 6A is a cross-sectional view of the socket 11b in the insertion position to allow the pin 12 to be inserted thereinto, and FIG. 6B is a cross-sectional view of the state in which the socket 11b starts being pressed by the pin 12. FIG. 6C is a cross-sectional view of the socket 11b in the clamp position to clamp the pin 12. FIG. 6D is a cross-sectional view of the state where the pin 12 is removed from the socket 11b, and returns to the insertion position illustrated in FIG. 6A from the clamp position illustrated in FIG. 6C.

The material for the socket 11b illustrated in FIGS. 6A to 6D may be any material that deforms in accordance with the shape of the pin 12 when the pin 12 presses the socket 11b, and, as illustrated in FIG. 6D, that restores to the shape of the insertion position when the pin 12 is removed from the socket 11b.

In the present embodiment, as illustrated in FIG. 6A, the socket 11b may have the contact points 16b, at which the socket 11b comes into contact with the pin 12, at specific positions of the socket 11b (for example, shaded portions in FIG. 6A), and the portions other than the contact points 16b may be formed from a non-conductive material. The portions of the socket 11b at which the contact points 16b are disposed may be any portions at which the socket 11b and the pin 12 come into contact with each other in the state illustrated in FIG. 6C in which the socket 11b is shaped so as to tightly clamp the pin 12.

Thus, as illustrated in FIG. 6B, when the pin 12 starts pressing the socket 11b and the socket 11b has not completely clamped the pin 12, the pin 12 and the socket 11b are prevented from establishing unnecessary electrical connection therebetween. As illustrated in FIG. 6C, in the state where the socket 11b is tightly clamping the pin 12 (specifically, in the state where the contact points 16b of the socket 11b are in secure contact with the pin 12), the pin 12 and the socket 11b can establish preferable electrical connection therebetween.

### Sixth Embodiment

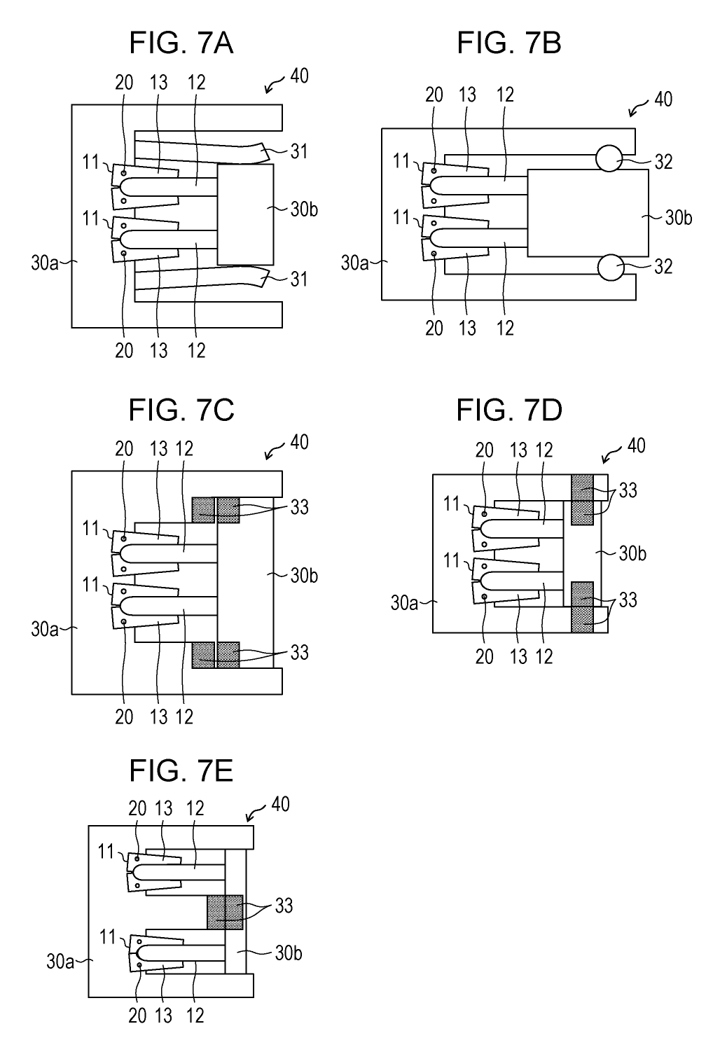

FIG. 7A is a cross-sectional view of a connector 40 (hereinafter simply referred to as a connector 40) including a female housing 30a and a male housing 30b, in a fixed position.

As illustrated in FIG. 7A, the female housing 30a has an angular C-shaped cross section, and accommodates two sockets 11 inside the angular C-shaped space. The male housing 30b has a rectangular parallelepiped shape having a rectangular cross section, and on which two pins 12 are mounted. On the female housing 30a, two plates 31 are mounted as fastening members that clamp the upper end and the lower end of the male housing 30b to hold the male housing 30b in the clamp position. The plates 31 are not limited to two, and may be more than two. The plates 31 may have a ring shape.

In the structure illustrated in FIG. 7A, two sockets 11 are mounted on the female housing 30a, but the number of sockets 11 mounted on the female housing 30a is not limited to two. Likewise, the number of pins 12 mounted on the male housing 30b is not limited to two.

The shape of the female housing 30a is not limited to an angular C shape, and may be any shape that allows the sockets 11 and the fastening members to be attached thereto. Likewise, the shape of the male housing 30b is not limited to a rectangular parallelepiped shape, and may be any shape that allows the pins 12 to be mounted thereon and that can be held by the fastening members.

The material of the fastening members mounted on the female housing 30a may be any elastic material capable of clamping the male housing 30b, such as metal, resin, or rubber.

Examples of a method for the female housing 30a to fix the male housing 30b include to dispose an O-ring 32 in the gap between the female housing 30a and the male housing 30b, as illustrated in FIG. 7B, and to dispose magnets 33 at contact portions at which the female housing 30a and the male housing. 30b come into contact with each other, as illustrated in FIG. 7C or FIG. 7D.

In FIGS. 7 and 7D, two magnets 33 are disposed on each of the female housing 30a and the male housing 30b. However, the number of magnets 33 is not limited to this. For example, as illustrated in FIG. 7E, when the female housing 30a has an E-shaped cross section, the number of magnets 33 disposed on each of the female housing 30a and the male housing 30b may be one.

### Seventh Embodiment

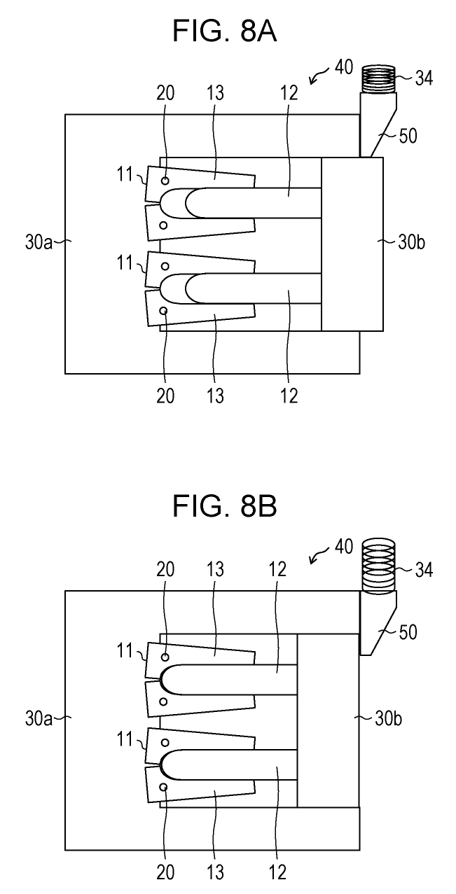

FIGS. 8A and 8B illustrate the method for physically fixing the female housing 30a and the male housing 30b to each other. FIG. 8A is a cross-sectional view of the state before the male housing 30b is physically fixed to the female housing 30a. FIG. 8B is a cross-sectional view of the state where the male housing 30b is physically fixed to the female housing 30a after being pressed into the socket 11 from the state in FIG. 8A.

As illustrated in FIG. 8A, an example of the method for physically fixing the connector 40 is to provide a sliding latch. 50 above the inlet (opening allowing insertion of the male housing 30b) of the female housing 30a. The latch 50 has a wedge-shaped cross section having a tapered wall surface inclined from the outside to the inside of the female housing 30a. A spring 34 is disposed on the latch 50. The spring 34 urges the latch 50 in the direction in which the latch 50 closes the inlet of the female housing 30a. The spring 34 thus disposed slides the latch 50 downward to fix the male housing 30b when the male housing 30b is fitted into the female housing 30a, as illustrated in FIG. 8B. In FIGS. 8A and 8B, only one latch 50 is disposed at the inlet of the female housing 30a. However, the number of latches 50 is not limited to one, and may naturally be plural.

### CONCLUSION

As described above, the socket 11 (female terminal) according to a first aspect of the present disclosure is electrically connectable to a pin 12 (male terminal) inserted thereinto. The socket 11 includes a pressed portion 14, which is pressed by the pin 12, and clamp pieces 13 (clamp portions), which are deformed, in response to the pressed portion 14 being pressed, into a clamp position, in which the clamp pieces 13 clamp the pin 12, from an insertion position, in which the clamp pieces 13 allow the pin 12 to be inserted thereinto.

In the above structure, in response to the pressed portion 14 being pressed by the pin 12, the clamp pieces 13 for clamping the pin 12 therebetween are deformed into the clamp position. Thus, the clamp pieces 13 clamp the pin 12 therebetween to establish electrical connection therebetween.

Specifically, the pin 12 is in noncontact with the clamp pieces 13 until it presses the pressed portion 14, so that wear of the pin 12 and the socket 11 caused by sliding over each other at the connection is reduced to hinder dirt such as plating residues. Furthermore, this structure can hinder dirt such as plating residues from intruding into a contact portion between the pin 12 and the socket 11, so that the reliability of electrical connection is improved and degradation of the pin 12 or the socket 11 due to sliding is reduced. Thus, the lives of the socket 11 and the pin 12 can be prolonged.

To describe the structure of the socket 11 more specifcally, the multiple clamp pieces 13 of the socket 11 face each other. When the pressed portion 14 is pressed, the clamp pieces 13 move in the direction in which they clamp the pin 12 therebetween, and are deformed from the insertion position to the clamp position.

In the above structure, when the pressed portion 14 is pressed by the pin 12, the clamp portions formed from the clamp pieces 13 for clamping the pin 12 therebetween are deformed into the clamp position to clamp the pin 12 therebetween to establish electrical connection therebetween.

Thus, the socket 11 and the pin 12 are in contact with each other at multiple contact points. Thus, when the clamp pieces 13 are deformed into the clamp position, the clamp pieces 13 can more securely clamp the pin 12 therebetween.

The number of clamp pieces 13 facing each other is not limited to two. For example, the number of clamp pieces 13 may be three or four, as illustrated in FIGS. 2A to 2G, or may be five or more.

In addition to the components according to the first aspect, the socket 11 according to a second aspect of the present disclosure also includes the flat spring 19a, the springs 19b, or the magnets 19c, which urges/urge the multiple clamp pieces 13 away from each other in the insertion position.

In the above structure, the flat spring 19a, the springs 19b, or the magnets 19c, which urges/urge the clamp pieces 13 away from each other returns/return the socket 11 to the insertion position, in which the socket 11 allows the pin 12 to be inserted thereinto, concurrently with an operation of removing the pin 12 from the socket 11.

Thus, wear between the pin 12 and the socket 11 caused when the pin 12 is removed can be more reliably reduced.

Besides the components according to the first aspect, in a socket 11 according to a third aspect of the present disclosure, clamp pieces 13 rotate about rotation shafts 20 disposed on the socket 11 to move in directions to clamp the pin 12 therebetween.

In the above structure, the clamp pieces 13 rotate about the rotation shafts 20 disposed on the clamp pieces 13 to clamp the pin 12 therebetween.

Thus, the clamp pieces 13 of the socket 11 can accurately rotate about the rotation shafts 20 to clamp the pin 12 therebetween to establish stable electrical connection therebetween.

Besides the components according to the first aspect, a socket 11 according to a fourth aspect of the present disclosure includes an elastic material having an urging force for urging the clamp pieces 13 away from each other in the insertion position.

In the above structure, when the pin 12 presses the socket 11 formed from an elastically deformable elastic material, the socket 11 is elastically deformed in accordance with the shape of the pin 12, so that the socket 11 and the pin 12 can establish electrical connection therebetween.

Thus, the socket 11 including multiple components can be formed of a single unit to reduce costs for components.

A connector 40 according to a fifth aspect of the present disclosure includes a pin 12, which is electrically connectable to the socket 11 according to any one of the first to fourth aspects. The connector 40 includes the plates 31 (fastening members) for fixing the position of the pin 12 with respect to the socket 11 in the clamp position. In the connector 40, the plates 31 fix the position of the pin 12 with respect to the socket 11, so that the pin 12 and the socket 11 are kept being fitted to each other to establish stable electrical connection therebetween for maintaining preferable connection.

Besides the connector 40 according to the above fifth aspect, in a connector 40 according to a sixth aspect of the present disclosure, at least one of the tip portion of the pin 12 and the pressed portion 14 is formed from a wear-resistant material.

In the above structure, the tip portion of the pin 12 and the pressed portion 14 of the socket 11, which are more likely to cause wear with repeated use, improve the wear resistance. Thus, the socket 11 and the pin 12 are prevented from being degraded due to wear caused by sliding each other during connection, and thus have their lives prolonged.

A gap is formed between the socket 11 and the pin 12 in the area in which the pin 12 is enclosed in the socket 11 in the clamp position, except the contact points at which the socket 11 and the pin 12 are electrically connected together and the pressed portion 14.

In this structure, the portions at which the socket 11 and the pin 12 in the clamp position are in contact with each other can be limited to the contact points, at which the female terminals and the pin 12 are electrically connected together, and the pressed portion 14. Thus, wear caused by sliding over each other for connection can be reduced.

The present disclosure is not limited to the above-described embodiments, and may be changed in various manners within the scope disclosed in claims. Embodiments obtained by appropriately combining technical components disclosed in the different embodiments are also included in the technical scope of the present disclosure.

The present disclosure contains subject matter related to that disclosed in Japanese Priority Patent Application JP 2018-072610 filed in the Japan Patent Office on Apr. 4, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A female terminal electrically connectable to a male terminal inserted thereinto, comprising:
a pressed portion that is pressed by the male terminal; and
a clamp portion that is deformed, in response to the pressed portion being pressed, into a clamp position, in which the clamp portion clamps the male terminal, from an insertion position, in which the clamp portion allows the male terminal to be inserted thereinto.

2. The female terminal according to claim 1,
wherein the clamp portion includes a plurality of clamp pieces that face each other, and
wherein when the pressed portion is pressed, the plurality of clamp pieces move in a direction in which the clamp pieces clamp the male terminal therebetween, and are deformed from the insertion position to the clamp position.

3. The female terminal according to claim 2, further comprising:
an urging portion that urges the plurality of clamp pieces away from each other in the insertion position.

4. The female terminal according to claim 2,
wherein the plurality of clamp pieces rotate about rotation shafts disposed on the female terminal to move in directions to clamp the male terminal therebetween.

5. The female terminal according to claim 2,
wherein the female terminal includes an elastic material having an urging force that urges the plurality of clamp pieces away from each other in the insertion position.

6. A connector, comprising:
the female terminal according to claim 1;
a male terminal electrically connectable to the female terminal; and
a fastening member that fixes a position of the male terminal with respect to the female terminal in the clamp position.

7. The connector according to claim 6,
wherein at least one of a tip portion of the male terminal and the pressed portion is formed from a material having wear resistance.

8. The connector according to claim 6,
wherein a gap is formed between the female terminal and the male terminal in an area in which the male terminal is enclosed in the female terminal in the clamp position, except a contact point at which the female terminal and the male terminal are electrically connected to each other and the pressed portion.
